(19) United States
(12) Patent Application Publication
(10) Pub. No.: US 2008/0188212 A1
(43) Pub. Date: Aug. 7, 2008

(54) Method and System for Managing User Equipment Functionality

(75) Inventors: Jia Li, Shenzhen (CN); Jiuyou Lv, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD., Shenzhen (CN)

(21) Appl. No.: 12/102,332

(22) Filed: Apr. 14, 2008

Related U.S. Application Data
(63) Continuation of application No. PCT/CN2007/000160, filed on Jan. 16, 2007.

(30) Foreign Application Priority Data
Mar. 13, 2006 (CN) 200610057406.9

(51) Int. Cl. H04M 3/00; H04Q 7/32

(52) U.S. Cl. 455/418; 455/456.4

(57) ABSTRACT

A system for managing functionality of a user equipment (UE) in a specified area. If the operator providing the network determines a requirement of disabling a UE function in the specified area, the network configures a UE function indication according to the requirement and sends the UE function indication via a system message of the cells covering the specified area by broadcast. A UE receives the UE function indication. The UE adjusts the UE function according to the UE function indication.

### CROSS-REFERENCE TO RELATED APPLICATIONS

This application is a continuation of PCT/CN2007/000160 filed on Jan. 16, 2007. This application claims the benefit of CN 200610057406.9, filed Mar. 13, 2006. The disclosures of the above applications are incorporated herein by reference.

### FIELD

The present disclosure relates to the field of telecommunications and to the management of user equipment (UE) functionality.

### BACKGROUND

The statements in this section merely provide background information related to the present disclosure and may not constitute prior art.

With the development of telecommunication technologies, UE's, such as mobile phone terminals, have gained more and more powerful functionality, e.g., camera functionality and flash storage functionality. Mobile phone terminals of today are able to do tasks that required specialized equipment in the past. With the increased functionality of mobile terminals, it has become increasingly difficult to restrict specific mobile phone functions in specified geographic areas. For example, photography is forbidden in some sensitive areas. The traditional method to prevent photography is to prohibit carrying cameras into these areas. However, mobile phone terminals may take photographs. It is not feasible to prohibit mobile phone terminals in these areas. It is also not feasible to prohibit mobile phone terminals that have photographic functionality in these areas.

Therefore, there is a need for a system or method to manage UE functionality to prevent unwanted functions in specified geographic areas.

### SUMMARY

Embodiments of the present invention provide a method and system for managing UE functionality to effectively resolve the management problem for multi-function user equipment in some sensitive areas by disabling or enabling a function of UE in a special area.

In various exemplary embodiments, a method for managing functionality of a UE in a specified area is provided. The method includes that a network receives a requirement of disabling a UE function in a specified area. The network configures a UE function indication according to the requirement and sends the function indication via a system message of the cells covering the specified area. A UE obtains the UE function indication and disables the UE function according to the UE function indication.

In other exemplary embodiments, a system for managing functionality of a UE in a specified area is described. The system includes a UE and a network device in the network side. The network device includes a configuring module and a sending module. The UE includes a function management module. The configuring module is capable of configuring a UE function indication in a system message of the cells covering the specified area, according to the requirement of disabling a UE function in the specified area, received by the network device. The sending module is capable of sending the system message configured by the configuring module. The function management module is capable of obtaining the UE function indication from system message received by the UE and disabling the UE function according to the UE function indication.

In other exemplary embodiments, a network device is provided. The network device includes a configuring module and a sending module. The configuring module is capable of configuring a UE function indication in a system message of the cells covering the specified area, according to a requirement of disabling a UE function in the specified area, received by the network device. The sending module is capable of sending the system message configured by the configuring module, so that a UE disables the UE function according to the UE function indication in the system message.

In various exemplary embodiments, a UE is provided. The UE includes a function management module, which is capable of obtaining a UE function indication from network and capable of disabling the UE function indicated by the UE function indication.

In various embodiments, the network takes UE functions as the object of network management. Thus, the UE can enable or disable user equipment function in a specified area. The various embodiments can effectively resolve the problem of management for multi functions of UE in a sensitive area.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a flowchart according to various embodiments.

FIG. 2 is a schematic drawing illustrating the state of the cells before an operator adjusts network planning for an area where a UE's function is to be disabled.

FIG. 3 is a schematic drawing illustrating the state of cells after an operator adjusts network planning for an area where a UE's function is to be disabled.

FIG. 4 is a block diagram illustrating an exemplary structure of UE according to various embodiments.

FIG. 5 is a work schematic diagram of the function management module of UE according to various embodiments.

### DETAILED DESCRIPTION

The following description is merely exemplary in nature and is not intended to limit the present disclosure, application, or uses.

According to various embodiments, the following discloses a system for managing UE functionality in a geographic area. The network controls the function of user equipment such as mobile phone terminals as a network management objective. To limit mobile phone terminals functionality in a specified area, a network sets an information element in the cell system message of the specified area. The information element indicates which functions of a UE are to be enabled or disabled. This provides a value added service for operators and can effectively solve the problem of managing multi function mobile phone terminals in sensitive areas.

FIG. 1 describes a method for managing UE functionality in accordance with various embodiments. Referring to FIG. 1, the method may be described as follows:

In block 1 of FIG. 1, a process classifies various UE functions into a plurality of different categories and defines a UE function indication for each category of functions. This indication is utilized by both the network and the UE.

In block 1, the classification of UE functions may be provided based on the purpose of the functions. The classification may be used to allow for future development of functionality. In various embodiments, the functions of UE are classified as follows:

Category One: Speaker Function

This category may include those functions currently existing or appearing in the future that may cause noise pollution, such as ringing tone function and speaker function. Furthermore, the speaker function may be applied to hands free set or MP3 player.

Category Two: Camera Function

This category may include those video functions currently existing or appearing in the future, such as a still camera function, video playback function and record function.

Category Three: Non-Network Connection Data Communication Function

This category may include those non-network connection data communication functions currently existing or appearing in the future, such as any one or more infrared connection functions, blue tooth connection functions and data line connection functions.

Also, in block 1, a UE function indication is configured such that each code is set to correspond to each category. In various embodiments, the indication is utilized by both the network and the UE. For example, the code may be a binary code (such as 1 or 0) to indicate whether a category of functions is disabled. In one embodiment, the “1” may represent disablement of a category of functions and the “0” may represent enablement of a category of functions.

Because the network and UE know about the UE function indication, the UE may control the corresponding function according to the UE function indication of the message obtained from the network.

In block 2, if a requirement for disabling a UE function is submitted to the network covering an area, the network adjusts network planning so that there are one or more dedicated cells that cover the specified area. The network configures the UE function indication according to the requirement. In various embodiments, the network sends by broadcast the UE function indication via an added information element, such as a “UE RESTRICTED FUNCTION CLASSMARK” of the cell system message (e.g., “System Information Block type1”).

In block 2, if the requirement is submitted to the network covering the area for disabling a UE function and there are no dedicated cells covering the area, the network can not distinguish between the specified area and other areas. In this situation, the network planning may need to be adjusted so that there are one or more dedicated cells covering the specified area.

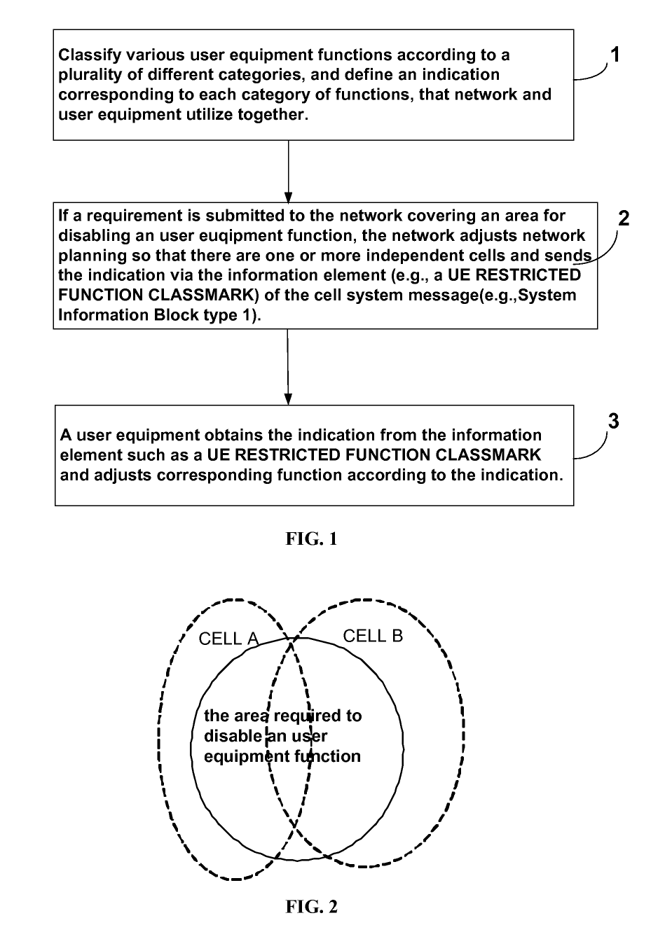

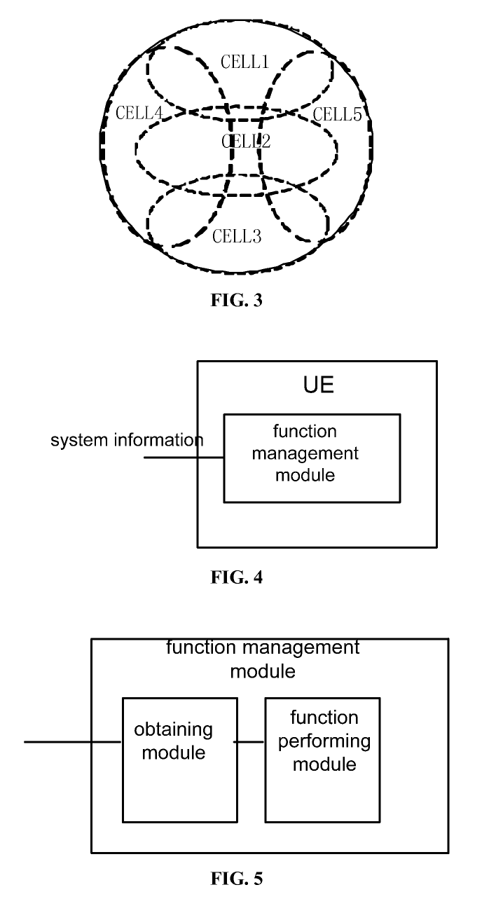

For example, referring to FIG. 2, the area surrounded by the solid line is the specified area and a requirement is submitted to disable a category of functions in this specified area. Cell A and/or cell B, denoted by broken lines, cover the specified area, but also cover other areas. Limiting UE functionality of cell A and/or cell B would not be acceptable, as it would affect an area out side of the specified area. Therefore, the network adjusts network planning according to the requirement so that there are one or more dedicated cells. The dedicated cells are shown in FIG. 3. Referring to FIG. 3, there are five cells, from cell 1 to 5, covering the area surrounded by the solid line. If there are one or more dedicated cells, only covering the area, it is not necessary to adjust the network planning.

After the network planning is adjusted, the network sets a UE function indication according to the requirement of the specified area. In various embodiments the network sends the UE function indication via an information element, such as a UE RESTRICTED FUNCTION CLASSMARK, in the system message (e.g., System Information Block type1).

For example, in the format of the information element, such as a UE RESTRICTED FUNCTION CLASSMARK, the information element may be configured as a single byte, and each bit may represent a category of UE functions. To allow for future technologies, the information element may preserve extension bits for later use. In some embodiments the format of the information element is shown in table 1:

| | Non-network | | |
|---|---|---|---|
| | connection data | | |
| Reserved | communication | | |
| extension bits | function | Camera function | Speaker function |
| 5 bits | 1 bit | 1 bit | 1 bit |

Referring to table 1, in various embodiments, if the information element is defaulted to a certain value, such as 0, this default value allows the functions to be enabled. If the value of a bit of the information element is 1, the function corresponding to the bit is disabled. If the value of a bit of the information element is 0, the function corresponding to the bit is enabled.

For example, in a specified area where quiet is required, such as in a hospital or a theater, if it is necessary to disable the ringing tone function of UE, a requirement for disabling the ringing tone function is sent to the network covering the specified areas. If the network obtains the requirement, the network modifies a configuration parameter of the cell covering the specified area. The network sets the value of the bit corresponding to the speaker function in the information element such as a UE RESTRICTED FUNCTION CLASSMARK to the value for disabling (e.g., 1). The network sends the UE indication for disabling the ringing tone function via the information element of the system message such as System Information Block type1.

In block 3 of FIG. 1, if a UE receives the system message such as System Information Block type 1, the UE obtains the UE function indication from the information element such as UE RESTRICTED FUNCTION CLASSMARK. The UE disables the corresponding function according to the UE function indication.

For example, when a UE enters a specified area where a UE function is prohibited, the UE obtains the information element such as UE RESTRICTED FUNCTION CLASSMARK of the system message such as System Information Block type1 by broadcasted. The UE learns the disabling of the ringing tone function by the information element and disables the corresponding ringing tone function according to the user function indication. In this way, the possibility of noise pollution caused by ringing tone is avoided.

When a UE is away from the specified area where a UE function is disabled and enters a new area; the UE obtains the UE function indication according to the information element of the system message of the new area. According to the indication, the UE may enable the corresponding function again.

According to other embodiments, the system of FIG. 4 discloses UE that includes a function management module.

When the UE receives a system message, if the function management module obtains a UE function that indicates disabling a function; the function management module disables the corresponding function. If the function management module obtains the UE function indication of the system message indicating enabling one or more function, the function management module enables the corresponding functions.

FIG. 5 shows a schematic diagram illustrating an exemplary structure of the function management module. In various embodiments the function management module includes an obtaining module and a function performing module. If the UE receives a system message, the obtaining module analyzes the system message. If the obtaining module obtains the UE function indication indicated disabling a function (e.g., from the information element such as a UE RESTRICTED FUNCTION CLASSMARK of a system message), the obtaining module sends the indication to the function performing module. The function performing module disables the corresponding UE function according to the function indication. After the corresponding UE function is disabled, if the obtaining module obtains a UE function indication indicated to enable the function from the information element such as UE RESTRICTED FUNCTION CLASSMARK of the system information message, the obtaining module sends the indication to the function performing module. The function performing module enables the corresponding UE function according to the function indication.

In various embodiments, a network device is located at the network side and has a configuring module and a sending module. If the network equipment receives a UE function disabling requirement for a specified area, the configuring module of the network device sets a user equipment function indication in the system message of the cell covering the area. In some embodiments, the configuring module sets the UE function indication in the information element such as UE RESTRICTED FUNCTION CLASSMARK of the system message. The sending module sends the system message set by the configuring module. The detail configuration of the information element of the system message may be referred to the description in the above method embodiments

In some embodiments, the information element is set to a default value in the system message in areas where UE functionality is not limited. In other embodiments the default value (e.g., 0) represents enablement of a UE function.

In some embodiments, if the requirement to disable a UE function in the geographic area is submitted to the network and if there are no dedicated cells covering the area, the network equipment will include a network planning adjustment module. The network planning adjustment module adjusts network planning so that there are one or more cells covering only the specified area. The details about network planning adjustment may be the same as the description of the method embodiments of the present invention.

Various embodiments provide a system for managing UE functionality. The system includes a UE and a network device located on the network. The network device includes a configuring module and a sending module. Optionally, the network device has a network planning adjustment module. In various embodiments, the user equipment also has a function management module and the operation of the function management module is performed by an obtaining module and a function performance module.

In some embodiments, the details about the operation between each modules in the system for managing user equipment functionality is the same as the description of the user equipment embodiment and the network equipment embodiment.

The system disclosed herein addresses management of multi-function user equipment in some sensitive area by the user equipment function indication in the system message indicating disabling user equipment function. The implements are low cost, easily performed, and can obtain an effective management result.

The description of the various embodiments are provided to enable a person skilled in the art to make or use them. Various modifications to the embodiments will be readily apparent to those skilled in the art, and the generic principals defined herein may be applied to other embodiments. Thus, the subject teachings are not intended to be limited to the various embodiments shown herein, but are to be accorded the widest scope consistent with the principals and novel features disclosed herein.

What is claimed is:

1. A system for managing functionality of a user equipment (UE) in a specified area, comprising:
a function management module, capable of
obtaining a UE function indication from a network, and
managing a function of the UE based on the function indication.

2. The system of claim 1, wherein the managing a function comprises enabling or disabling the function of the UE indicated by the UE function indication.

3. The system of claim 2, wherein the UE is capable of receiving the function indication via broadcast.

4. The system of claim 3, wherein the function management module further comprises:
an obtaining module in communication with a function performing module;
the obtaining module, capable of obtaining the UE function indication in a system message from network, and sending the UE function indication to the function performing module; and
the function performing module, capable of receiving the UE function indication from the obtaining module, and disabling or enabling the UE function indicated by the UE function indication.

5. A system for managing functionality of a user equipment (UE) in specified areas, comprising:
a configuring module; and
a sending module in communication with the configuring module, the configuring module is capable of configuring a UE function indication for disabling or enabling a function of a UE in a specified area, the sending module is capable of sending the UE function indication to the UE.

6. The system of claim 5 further comprising a network planning adjustment module, capable of adjusting network planning for the specified area to cause one or more cells dedicated to the specified area, if there are no dedicated cells.

7. The system of claim 6, wherein the network device receives a requirement of disabling or enabling the UE function in the specified area and the network device configures the UE function indication according to the received requirement for disabling or enabling the UE function.

8. A system for managing functionality of a user equipment (UE) in a specified area, comprising:
a network device in communication with the UE, wherein the network device is capable of configuring and sending a UE function indication to the UE and the UE function indication is representative of to disabling or enabling a UE function, wherein the UE is capable of obtaining the UE function indication from the network device, and disabling or enabling the UE function indicated by the UE function indication.

9. The system of claim 8, wherein the network device receives a requirement of disabling or enabling the UE function in the specified area.

10. The system of claim 9, wherein the network device comprises:
a sending module;
a configuring module in communication with the sending module, wherein the configuring module is capable of configuring a UE function indication for disabling or enabling a function of a UE in a specified area, and the sending module is capable of sending the UE function indication to the UE.

11. The system of claim 10, wherein the network device further comprises a network planning adjustment module, capable of adjusting network planning for the specified area to cause one or more cells to be dedicated to the specified area if there are no dedicated cells.

12. The system of claim 8, wherein the UE further comprises:
a function performing module; and
an obtaining module in communication with a function performing module; wherein the obtaining module is capable of obtaining the UE function indication in a system message from the network and sending the UE function indication to the function performing module; the function performing module is capable of receiving the UE function indication from the obtaining module and is capable of disabling or enabling the UE function indicated by the UE function indication.

13. A method for managing functionality of a user equipment (UE) in a specified area, comprising:
obtaining, by a UE, a UE function indication from a network; and
disabling or enabling, by the UE, a UE function based on the UE function indication.

14. The method of claim 13, wherein the UE function indication is contained in a system message of the network.

15. The method of claim 14, wherein the UE function indication is contained in an information element of the system message of the network.

16. The method of claim 15, wherein categories of UE functions indicated by the UE function indication comprise non-network connection data communication function, or camera function, or speaker function.

17. A method for managing functionality of a user equipment (UE) in a specified area, comprising:
configuring, by a network device, a UE function indication for disabling or enabling a UE function in the specified area, and
sending, by the network device the UE function indication to a UE.

18. The method of claim 17, comprising:
classifying various UE functions into a plurality of different categories and
defining the UE function indication for each category of functions, wherein the UE function indication is utilized by both the network and the UE.

19. The method of claim 18, wherein the categories of UE functions comprise at least one of non-network connection data communication function, camera function, or speaker function.

20. The method of claim 19, further comprising:
receiving, by the network device, a requirement for disabling or enabling the UE function in the specified area; and
configuring, by the network device, the UE function indication according to the received requirement.

21. The method of claim 20, further comprising adjusting network planning for the specified area to cause one or more dedicated cells to the specified area, if there are no dedicated cells.
